(19) United States
(12) Patent Application Publication
(10) Pub. No.: US 2011/0213731 A1
(43) Pub. Date: Sep. 1, 2011

(54) TECHNIQUES FOR IDENTIFYING HIGH-RISK PORTFOLIO WITH AUTOMATED COMMERCIAL REAL ESTATE STRESS TESTING

(75) Inventors: Daniel Cho, Austin, TX (US); Kyoung S. Choe, Austin, TX (US); Josh Andrews, Austin, TX (US)

(73) Assignee: BANKER'S TOOLBOX, INC., Hollywood, CA (US)

(21) Appl. No.: 12/714,165

(22) Filed: Feb. 26, 2010

(51) Int. Cl. G06Q 40/00

(52) U.S. Cl. 705/36 R

(57) ABSTRACT

Techniques for providing automated commercial real estate stress testing are provided. The automated stress testing techniques use loan information and publicly available commercial real estate data to model the performance of commercial real estate loans. Banks can use the automated techniques to more efficiently and accurately predict the performance of the commercial real estate portfolios.

### BACKGROUND

1. Technical Field

The embodiments described herein relate to stress testing bank assets, and more particularly to stress testing commercial real estate loans.

2. Related Art

The commercial real estate (CRE) market is the single largest loan portfolio segment in most regional and community banks. Given this exposure to the CRE market, the significant health of the loans in this sector, or the lack thereof, can put these banks at significant risk. As a result, trends in commercial real estate tend to lag behind the rest of the economy, and the recent meltdown of residential mortgages may foretell the looming problems in the CRE market. The commercial real estate (CRE) market has attracted increased scrutiny from regulators. According to Federal Deposit Insurance Corporation (FDIC) data, banks had $1.8 trillion in commercial real estate loans on their books as of Jun. 30, 2009. The Federal Reserve announced plans for its analysts to perform “horizontal reviews” to assess the vulnerability of medium-sized lenders to falling CRE values in order to gauge the potential risks to the banking industry as a whole.

More than fifty percent of the CRE loan balance within the United States is held by the top 117 banks in the country. These banks have over $10 billion in total assets and tended to have more diverse loan portfolios than smaller regional banks. The remainder of the banks have a higher percentage of their total loan portfolios as CRE, putting these banks at greater risk.

The first CRE problem that banks face is the huge amount of debt with looming maturities. The CRE market is unsettled, making it difficult even for responsible property owners who have made payments on time and without failure to be able to refinance their current loans. As a result, many property owners limit their management of and capital investments in the property, as they begin to look for alternatives, and the value of the property can decline.

The decline in value can force a property owner into bankruptcy and can force the bank to take possession of the property. Banks want to rid themselves of these properties quickly and often sell these properties at “fire sale” prices that are well below market price. These sales can further depress the CRE prices to the detriment of other institutions and investors in the market.

Banks are also facing rising levels of non-performing CRE loans coupled with loan loss reserve that are not increasing in direct proportion to the loan losses. When these assets go into default, the bank will have to charge off the exposure. The amount of the charge off is based on the current value of the asset on the books and the value derived from a detailed impairment analysis. If the bank's loan loss reserve is inadequate, the capital accounts are at risk. When a bank's assets show deterioration, regulators expect greater provisions for loan loss; however, coverage ratios have been on a steady decline since 2007.

Banks with portfolios heavy in construction lending and income-producing real estate have the opportunity to mitigate some of the risk of their CRE portfolios through stress testing. CRE stress testing is a forward-looking approach at how economic factors, such as rising interest and vacancy rates, affect the loan portfolio's performance. Stress testing measures the effect of the entire CRE portfolio on an institution's credit quality and earnings performance. When stress testing is done properly, a banker can review a snapshot of the concentration segments within their portfolio and make more informed decisions.

Conventional stress testing techniques are often extremely data intensive, making such techniques a time consuming manual exercise for bank employees. Moreover, the banks may not have all of the information that is required to estimate the performance of the bank's loan portfolios. For example, some banks may only maintain basic information about loans in the portfolio, such as the loan amount, loan date, payment amount, and payment date. However, conventional CRE stress testing technique can require much more in depth information about a property, such as property type, cap rates, vacancy rates, project location, expenses, appraised value, loan-to-value ratio, net operating income, potential gross income, and debt service coverage. Furthermore, conventional CRE stress testing techniques may result in inaccurate estimates of the performance of the loan portfolio due to outdated data and/or data based on unrealistic expectations or assumptions. For example, the value of a property may have changed significantly since the last appraisal, and any calculations based on the outdated appraisal can result in an inaccurate estimate of a loan performance for that property.

### SUMMARY

Techniques for providing automated commercial real estate stress testing are provided. The automated stress testing techniques use loan information and publicly available commercial real estate data to model the performance of commercial real estate loans. Banks can use the automated techniques disclosed herein to more efficiently and accurately predict the performance of the commercial real estate portfolios.

In one aspect, a system for performing stress testing on commercial real estate loans comprises a commercial real estate stress test (CREST) server configured to automatically perform real estate stress testing for commercial real estate, wherein the CREST server is configured to perform the following steps: receiving loan information for a commercial property from a bank; retrieving real estate trend data from an external data source; estimate various values for use in automated commercial real estate stress testing based on the loan information from the bank and the real estate trend data from the external data source; and a commercial real estate (CRE) data store connected to the CREST server and configured to store data for the CREST server.

According to another aspect, a system for estimating a net operating income for a property comprises a commercial real estate stress test (CREST) server configured to automatically perform real estate stress testing for commercial real estate, wherein the CREST server is configured to perform the following steps: receiving loan information for a commercial property from a bank; retrieving real estate trend data from an external data source; determining an estimated present value of the commercial property based on an appraised collateral value for the property included in the loan information received from the bank and property value trend information included in the real estate trend data retrieved from an external source; determining an estimated current cap rate of the commercial property based on cap rate information included in the loan information and cap rate trend information included in the real estate trend data retrieved from an external source; determining an estimated net operating income of the commercial property based on the estimated present value of the commercial property and the estimated current cap rate of the commercial property; and a commercial real estate (CRE) data store connected to the CREST server and configured to store data for the CREST server.

These and other features, aspects, and embodiments are described below in the section entitled “Detailed Description.”

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is a block diagram of an example system that can be used to implement the CRE stress test techniques described herein according to an embodiment;

FIGS. 2A and B are diagrams illustrating the operation of a CREST server in accordance with certain embodiments;

FIG. 3 is a diagram illustrating example processes for segmenting portfolio data and the stressed data in accordance with various embodiments;

FIG. 4 is a flow diagram of a process for determining an Estimated Present Value of Property according to an embodiment;

FIG. 5 is a flow diagram of a process for determining Estimated Current Cap Rate of Income-Producing Real Estate according to an embodiment;

FIG. 6 is a flow diagram of a process for determining Estimated Current Net Operating Income Based on Estimated Current Property Value and Cap Rate according to an embodiment;

FIG. 7 is a flow diagram of a process for determining Estimated Current Loan-to-Value Ratio according to an embodiment;

FIG. 8 is a flow diagram of a process for determining Estimated Current Net Collateral Shortfall according to an embodiment;

FIG. 9 is a flow diagram of a process for determining Estimated Current Debt Service Coverage Ratio according to an embodiment;

FIG. 10 is a flow diagram of a process for determining Hypothetical Loan-to-Value Ratio according to an embodiment;

FIG. 11 is a flow diagram of a process for determining Estimated Hypothetical Net Collateral Shortfall according to an embodiment;

FIG. 12 is a flow diagram of a process for determining Estimated Hypothetical Debt Service Coverage Ratio of real estate based on changes to the income and payment according to an embodiment;

FIG. 13 is a block diagram illustrating an example CREST server according to an embodiment; and

FIG. 14 is a block diagram illustrating an example data management module according to an embodiment;

FIG. 15 is an example page from a CRE Stress Test Report according to an embodiment; and

FIG. 16 is another example page from a CRE Stress Test Report according to an embodiment.

### DETAILED DESCRIPTION

The following detailed description is directed to certain specific embodiments. However, it will be understood that these embodiments are by way of example only and should not be seen as limiting the systems and methods described herein to the specific embodiments, architectures, etc. In this description, reference is made to the drawings wherein like parts are designated with like numerals throughout.

The improved CRE stress testing techniques disclosed herein deploy a stress testing method that incorporates a model and some assumptions into the calculations that allow the CRE stress testing process to be automated and to use more up to date and accurate information to generate a more realistic estimate of loan performance. According to an embodiment, the improved CRE stress testing techniques include accessing publicly available CRE data sources that capture commercial real estate prices, transitions, default rates, and/or other relevant information for performing a CRE stress test. This data can be accessed based on the models and assumptions as well as the loan data as described below. According to an embodiment, an interface is provided for retrieving information from data sources having proprietary interfaces for accessing data in the data sources.

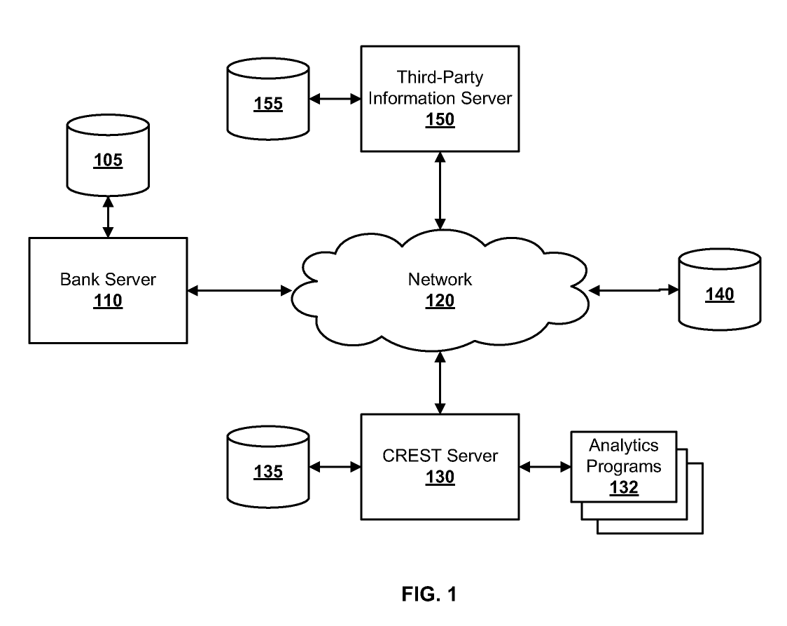

FIG. 1 is a block diagram of an example system that can be used to implement the CRE stress test techniques described herein according to an embodiment. The system includes a bank server 110 and a bank information data store 105. The bank server 110 comprises a computer server, or servers, that include one or more microprocessors for executing instructions. The bank server 110 can be configured to run various computer software programs for accessing, creating, and updating banking information on bank server 110. The bank information data store 105 can be a persistent data store, such as a relational database, for storing bank data, such as customer account information and loan information. In an embodiment, the bank server 110 can be connected to the bank information data store 105 via a wired or wireless connection or can be alternatively connected via one or more intermediate networks (not shown). According an alternative embodiment, bank information data store 105 can be implemented on bank server 110.

The bank server 110 can communicate with a CREST server 130 via a network 120. The network 120 can be a private network, a public network, a wired network, a wireless network, or any combination of the above, including the Internet. The CREST server 130 comprises a computer server, or servers, that include one or more microprocessors for executing instructions and includes various executable modules that can be used to implement the CRE stress test techniques disclosed herein. According to an embodiment, the CREST server 130 can provide CRE stress testing services to multiple banks. The data for each bank can stored in separate data stores to ensure data privacy. According to an alternative embodiment, the functionality of the CREST server 130 can be implemented in the bank server 110.

The CREST server 130 can be configured to automate CRE stress testing to eliminate the need for bank employees to perform time consuming and manual analysis of conventional CRE stress testing techniques that often use outdated data and can result in an inaccurate estimate of how the bank's CRE portfolio may perform based on changing market conditions. The CRE stress testing techniques implemented by the CREST server 130 use models based on the loan information and publicly available CRE information to more accurately predict the performance of the bank's CRE portfolio. The CRE stress testing can perform multiple-variable calculations simultaneously. The resulting output from the CREST server 130 can be used to measure the possible collateral shortfall and revised loan-to-value and debt service coverage ratios.

CRE data store 135 can comprise a persistent data store, such as a relational database, for storing CRE stress test data, such as data inputs used to perform CRE stress test calculations, intermediate results from CRE stress test calculation, and results of CRE stress test calculations. The CRE data store 135 can also include rules for performing various CRE stress test calculations. The CRE data store 135 can also include information identifying the sources of various inputs used in CRE stress test calculations, such as external data source 140 and third party information server 150 (described below). In an embodiment, the CREST server 130 can be connected to the CRE data store 135 via a wired or wireless connection or can be alternatively connected via one or more intermediate networks (not shown). According an alternative embodiment, CRE store 135 can be implemented on CREST server 130.

The CREST server 130 can obtain data used to estimate the performance of loan assets from various publicly available CRE data sources that capture commercial real estate prices, transitions, default rates, and/or other relevant information for performing a CRE stress test, such as third-party information server 150 or public CRE data source 140. The third-party information server 150 can be in communication with a third party data store 155, which can include data that can be used by the CREST server 130 for performing the various CRE stress testing techniques disclosed herein. In one embodiment, the third-party information server 150 is a web server.

The system illustrated in FIG. 1 merely includes two different publicly available data sources, but one skilled in the art would recognize that various embodiments of the CRE stress testing system could access CRE data from a different number of publicly available CRE data sources. In the example of FIG. 1, the CREST server 130 communicates with third-party information server 150 or public CRE data source 140 via network 120.

The third-party information server 150 and/or public CRE data source 140 can be offered by a government agency, non-governmental organizations, industry-related associations, or can be compiled by private companies, such as an online information provider server and/or banks. The CRE data may be accessible for free, or may require a subscription fee to access the data. In some embodiments, the CREST server 130 can implement one or more proprietary interfaces for accessing data stored on the third-party-information server 150 or the public CRE data source 140.

CREST server 130 can further comprise, be configured to run, or both, various programs, analytics, algorithms, etc. 132 that can be configured to enable the CREST server 130 to evaluate the bank loan information and to automatically determine information deficiencies, missing information, stale information, or information that should be substituted with more accurate information or more easily quantifiable information for purposes of testing. It is important that the CREST server 130 be able to identify what information needs to be added, deleted, updated, or substituted. These needs will be based on the type of model being applied, the type of risk being assessed, the types of properties being analyzed, the geographic location of the properties, etc.

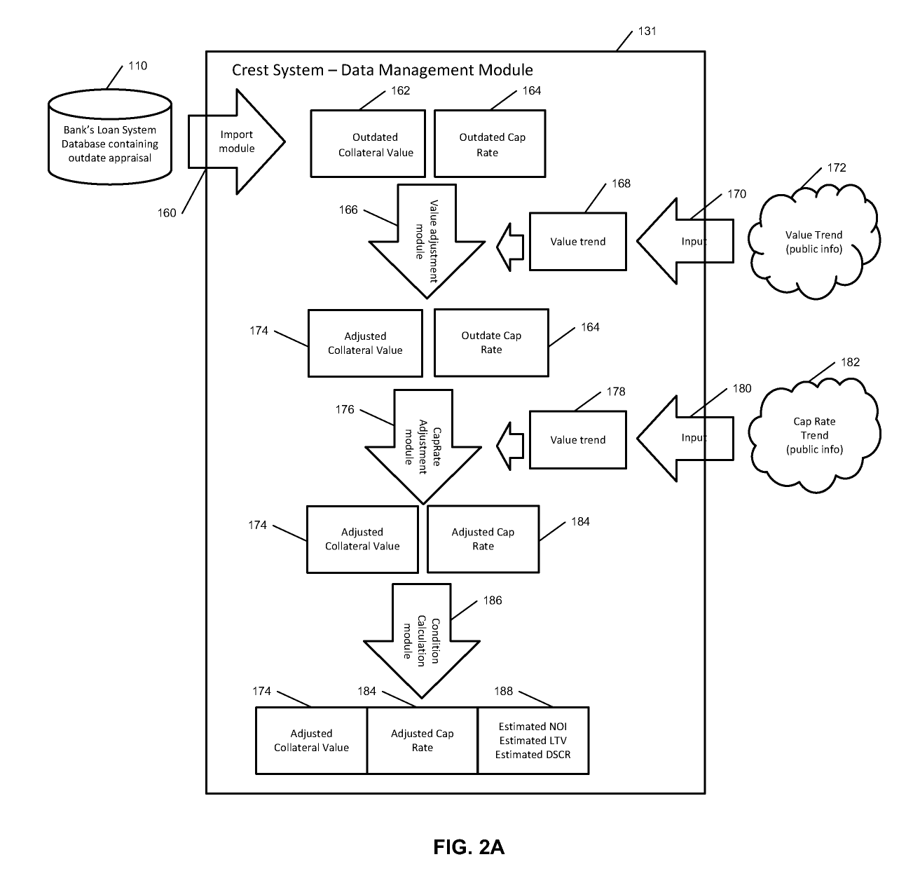

FIGS. 2A and B are diagrams illustrating the operation of CREST server 130 and programs 132 in accordance with certain embodiments. Specifically, FIG. 2A is a diagram illustrating the operation of a data management module group 131 that can be included in programs 132. First, group 131 can comprise an import module 160 configured to import data from bank server 110. Conventionally, banks are required to store data in what is referred to as an ALERT format. Thus, import module 160 can be configured to import information in the ALERT format and extract data from certain fields. These data can include collateral value and cap rate information for the loan portfolio. It is assumed that this information will be outdated. Accordingly, this data is illustrated as outdated collateral value 162 and outdated cap rate 164 in FIG. 2A. It is also assumed, as discussed in more detail below that this data includes as of dates indicated when the data was obtained. It should be noted that the loan data can be in ALERT format; however, the loan data may also be formatted in accordance with other formats, which can also be supported by server 130 depending on the embodiment.

A value adjustment module 166 included in group 131 can be configured to then generate an adjusted collateral value 174. In order to generate the adjusted collateral value 174, value trend data w68 can be obtained via input 170. Input 170 can be configured to receive, e.g., publicly available value trend information 172, e.g., from server 150, data source 140, or both. The value trend information 172 can be obtained either automatically as described above or it can be manually provided depending on the data and the embodiment. Value adjustment module is configured to generate the adjusted collateral value 174 based on the outdated collateral value 162, the as of date information, and the value trend 168 information.

A cap rate adjustment module 176 included in group 131 can be configured to then generate an adjusted cap rate 184 based on the outdated cap rate information 164, the as of date information, and cap rate trend data 178 received via input 180. Again, cap rate trend information can be obtained from, e.g., publicly available cap rate trend information obtained either automatically or manually from, e.g., server 150, data source 140, or both.

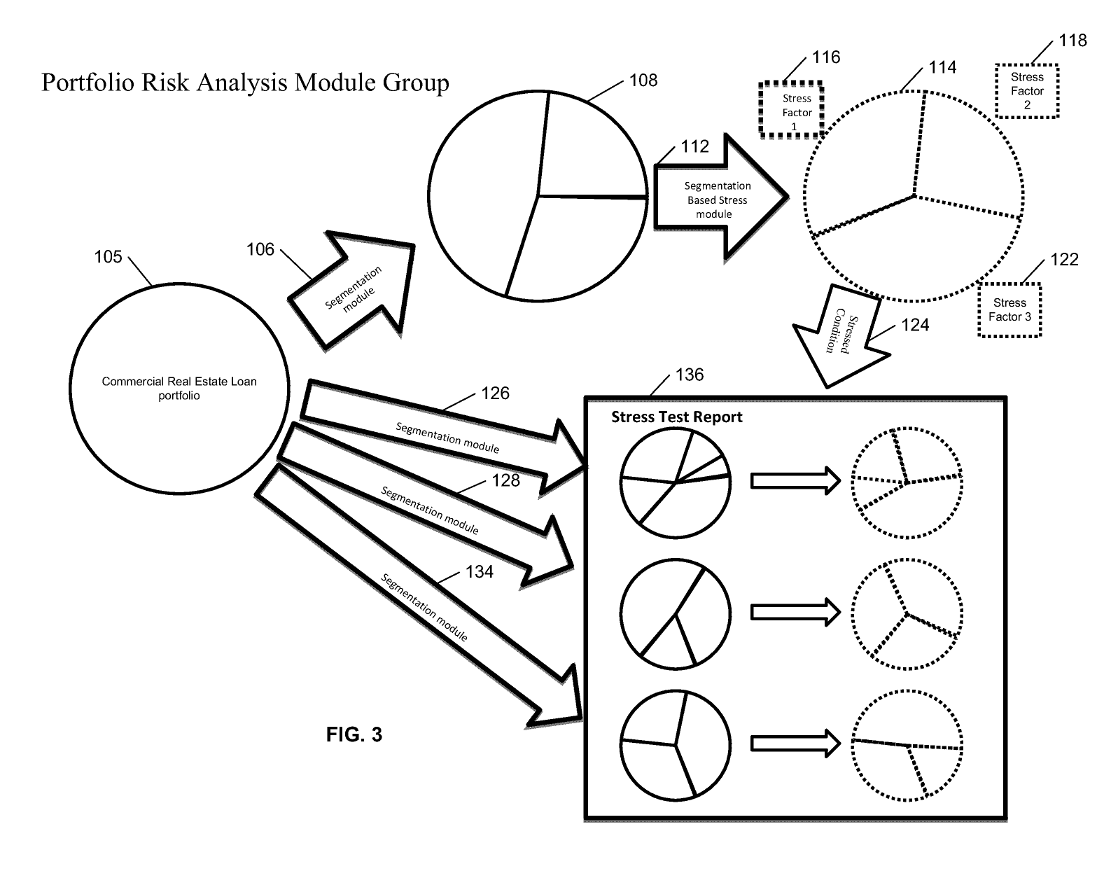

Condition calculation module 186 included in group 131 can be configured to then generate various estimated values 188, such as estimated net operating income, estimated loan to value ratios (LTVs), and estimated debt service coverage ratio (DSCR), using the adjusted collateral value 174 and adjusted cap rate 184. Various algorithms for deterring the estimated values 188 are described in detail with respect to FIGS. 4-12 below.

Once these values are determined, a stressed condition calculation module group 133 included in programs 132 can be employed to perform the stress testing referred to herein as illustrated in accordance with one example embodiment in FIG. 2B. In the example of FIG. 2B, the estimated net operating income (NOI) 188 is used in conjunction with the adjusted collateral value 174 and an interest rate 190, which can be obtained, e.g., from server 150 or data source 140, by stressed condition calculation module 191, which can be included in group 133 to determine various stressed data to indicate the risk associated with the portfolio.

In this example, a stress factor 192 obtained from, e.g., publicly available market forecast information via input 193, either manually or automatically, is used to determine the stressed data. The stress factor can, for example, be information such as a predicted 1% rise in interest rates or a predicted 10% decrease in collateral value in certain markets such as certain types of properties in certain area.

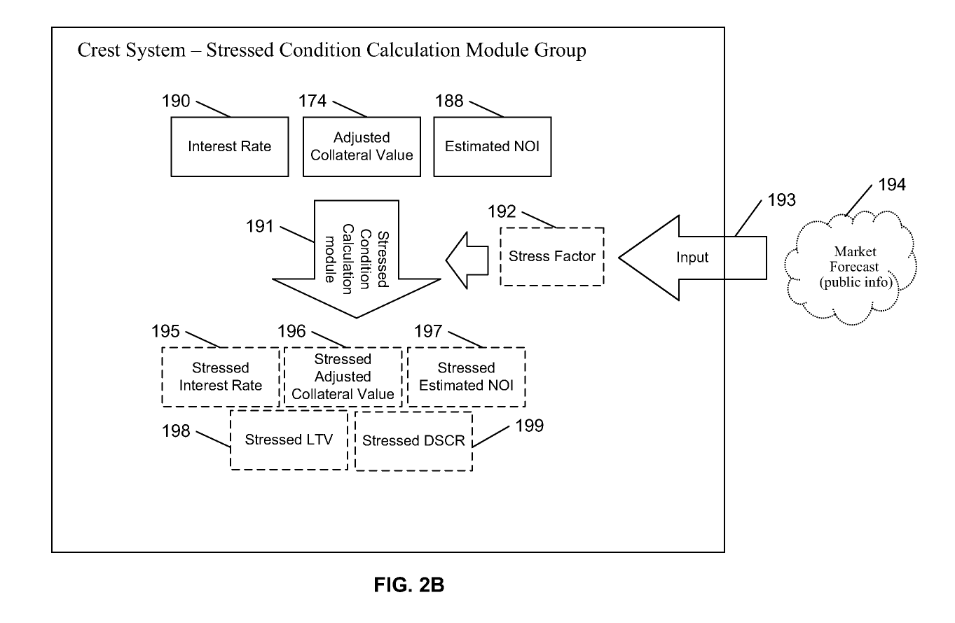

In the example of FIG. 3, the stressed condition module 191 generates a stressed interest rate 195, stressed adjusted value 196, stressed estimated NOI, stressed LTV, and stressed DSCR. This information can then be saved, e.g., in data store 135 and presented to the bank, e.g., as a report formatted as described with respect to FIG. 3.

FIG. 3 is a diagram illustrating example processes for segmenting the portfolio data and the stressed data in accordance with various embodiments. First, the portfolio information, e.g. stored in data store 105 can be segmented by a segmentation module 106 that can be included in programs 132. For example, the information can be segmented by property type, e.g., commercial, retail, and rental properties, to generate segmented portfolio 108. Segmentation based stress module 112 can be configured to then apply various stress factors 116, 118, and 122 to the segmented data 108 in order to generate segmented stressed data 114. In other words, the stressed data 195-199 can be segmented according to the segmentation applied by segmentation module 106.

Moreover, other segmentation modules 126, 128, and 134 can be configured to segment the data in different ways, e.g., by loan officer, branch location, etc. in order to produce a report 136 that shows the segmentation based stressed data 114 in different perspective. On top of 126, 128 and 134, one segment can be segmented further to view more granular analysis in report 136.

As noted above, FIGS. 4-12 illustrate various processes that can be used for generating estimated loan data related to loans on commercial real estate. These processes can be used in combination with one another to help a bank assess the strength of the loans in their CRE portfolio. The CREST server 130 can perform these processes for each of the loans in the bank's portfolio to generate a snapshot of the bank's CRE portfolio for use during stress testing. Thus, when implementing the processes illustrated in FIGS. 4-12, the CREST server 130 can access bank server 110 or bank information data store 105 to obtain the relevant loan data. The CREST server 130 can then run programs 132 on the data and determine whether, and what kind of additional data may be needed. The CREST server 130 can then access third party server 150, data source 140, or both to obtain the data. CREST server 130 can then apply the appropriate model to determine various estimated values for use in determining relevant risks.

FIG. 4 is a flow diagram of a process for determining an Estimated Present Value of Property according to an embodiment. The process illustrated in FIG. 2 can be implemented in the CREST server 130 illustrated in FIG. 1.

The Estimated Present Value of the Property can be determined using an appraised value of the property and the change in collateral values of property over time. The Estimated Present Value of the Property takes into account fluctuations in the collateral value of property over time and adjusts the appraised value of the property according to those trends. Whereas, in conventional approaches, the information is not necessarily updated to reflect present value. Adjusting the appraised value of the property according to trends in property value provides the CRE stress test with an estimated value for a property that is more likely to reflect the current market value for a property rather than an outdated appraisal value that may be out of date due to changes in the property market since the appraisal was taken. The property value trend can indicate that property values have increased, and thus, the value of the property may have increased since the appraisal, or that property values have decreased, and thus, the value of the property may have decreased since the appraisal.

According to an embodiment, historical appraisal information for a commercial property is retrieved (step 210). The historical appraisal information is information, for example, that is typically stored in bank information data store 105. The historical appraisal information includes an appraised collateral value and an appraisal date. The appraised collateral value represents the monetary value of the commercial real estate at the time of the appraisal date. The appraisal value is likely to have been derived by an appraiser and reported on an appraisal. In an embodiment, the CREST server 130 sends a request to the bank server 110 and/or bank information data store 105 to retrieve the historical appraisal information for the property from the bank information data store 105. The CREST server 130 can also request an “as of” date from the bank server 110 and/or bank information data store 105 that indicates the most recent date for which the loan information for the property was updated in the bank's records.

CREST server 130 can be configured to augment this data via data available, e.g., from a third party information server 150 or data source 140, such that more accurate data can be used. Whether to augment, and from which third party server 150 or CRE data source 140 can be dictated by programs 132 based, e.g., on the type of property, the area in which the property resides, date of the original appraisal, date of the last appraisal, etc. A determination is then made as to which property value trend data to use to derive the Estimated Present Value of the Property (step 220). The determination as to the trend data can then be stored in the CRE data store 135. This can allow, depending on the embodiment, for a determination to be made only once, and after that, new trend information will adjust all the CRE values automatically.

According to an embodiment, the property value trend data can be available as a series of time/value pairs that represent the proportional change of property values over time. In an embodiment, the time periods can be either quarterly, meaning that values represents a proportional changes of property values since the previous quarter of a particular year, or monthly, meaning that each value represents a proportional change of property values since the previous month. According to an embodiment, the value for each time/value pair can be expressed as an index value that represents the proportional change in property values since the previous index. For example, if the property trends indicate that the property values have increased by 10% in Quarter 1 of 2010, the index value for Quarter 1 would be 1.10. In another example, if the property trends indicate that the property values have decreased by 10% in Quarter 1 of 2010, the index value for Quarter 1 would be 0.90.

According to an alternative embodiment, the property value trend date can be expressed as a measure of price per square feet of a property. For example, commercial property may be $12.95 per square foot in the first quarter of 2010 that was $14.50 square foot at the first quarter of 2009.

According to an embodiment, the bank can select which type of property trend information to use and which source to use for obtaining the information. The bank's preferences can be stored in the CRE data store 135 and can be used by the models implemented by CREST server 130 and by programs 132.

The CREST server 130 retrieves the property value trend information from the selected source (step 230). The retrieved data can be stored in the CRE data store 135. A determination is made as to whether the historical appraisal data and the property trend information were available and were retrieved (step 240). If the data was unavailable, the CRE data store 135 can be updated to indicate that the Estimated Current Property Value could not be determined for this property (step 270). According to an embodiment, the CREST server 130 can attempt to access the information again at a later time. According to another embodiment, the CREST server 130 can periodically generate a report indicating that the required data could not be found for calculating the Estimated Current Property Value and/or other CRE stress test parameters.

According to an alternative embodiment, the CREST server 130 can be configured to provide a user interface that allows a user to manually enter the property value trend information. This allows the user to either select property value trend information from a publicly available source and to manually enter the information or to manually enter hypothetical values to project how different property value trends could impact the bank's CRE portfolio.

If the data was available either from a public source or was manually determined and entered by a user, then the Estimated Current Property Value can be calculated by CREST server 130 (step 250). In an embodiment, the Estimated Current Property Value can be calculated using equation (1) below:

$$Estimated Current Property Value = ( \frac{y - x}{x} + 100 \% ) \times Appraised Collateral Value$$

where:
x=the Property Trend Value corresponding to the Appraisal Date, and
y=the Property Trend Value corresponding to the “as of” date

The CREST server 130 then can update the CRE data store 135 to include the Estimated Current Property Value for the property (step 260). The Estimated Current Property Value can then be used to derive other stress test estimates related to the property.

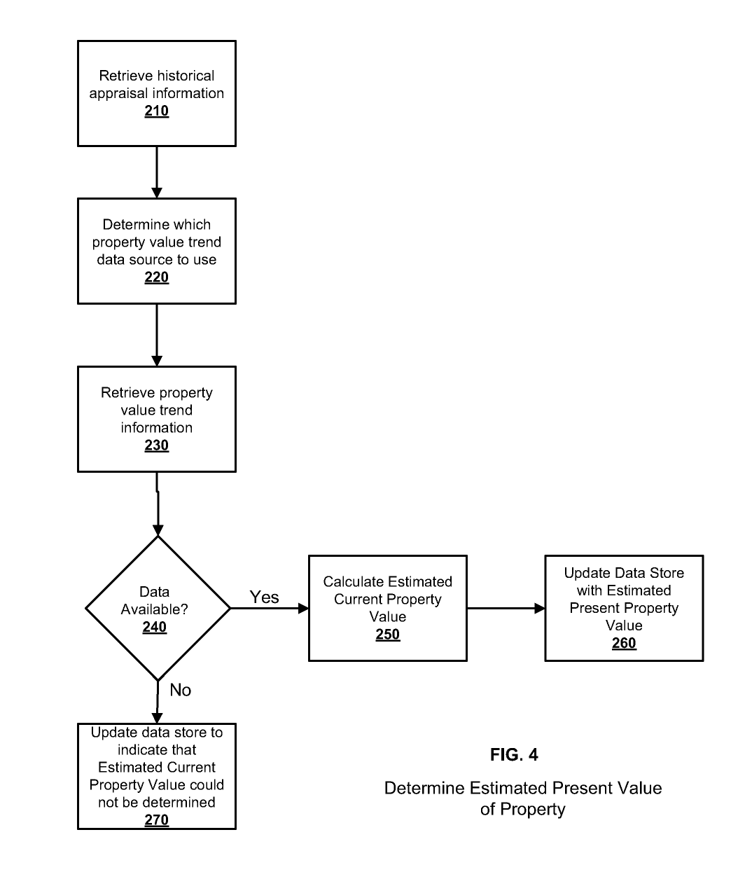

FIG. 5 is a flow diagram of a process for determining Estimated Current Cap Rate of Income-Producing Real Estate according to an embodiment. The Estimated Current Cap Rate of Income-Producing Real Estate can be determined using an appraised cap rate for the property and the change in the cap rate for the property over time. The Estimated Current Cap Rate of Income-Producing Real Estate takes into account fluctuations in the cap value of income-producing real property over time and adjusts the cap value of the property according to those trends.

According to an embodiment, historical appraisal information for a commercial property is retrieved (step 310). The historical appraisal information can include an appraised cap rate and an appraisal date. The capitalization rate for the income-producing property is likely to have been derived by an appraiser and reported on an appraisal. In an embodiment, the CREST server 130 can send a request to the bank server 110 and/or bank information data store 105 to retrieve the historical appraisal information for the property from the bank information data store 105. The CREST server 130 can also request an “as of” date from the bank server 110 and/or bank information data store 105 that indicates the most recent date for which the loan information for the property was updated in the bank's records.

In an embodiment, the historical appraisal information can have already been retrieved from the bank server 110 and/or bank information data store 105 for the property and stored in the CRE data store 135. If the historical appraisal information has already been retrieved for the property and is stored in the CRE data store 135, the CRE server 130 can retrieve the historical appraisal information from the CRE data store 135 instead of retrieving the data from the bank server 110 and/or bank information data store 105.

A determination is then made as to which cap rate trend data to use to derive the Estimated Current Cap Rate (step 320). The determination as to the trend data can then be stored in the CRE data store 135. This can allow, depending on the embodiment, for a determination to be made only once, and after that, new trend information will adjust all the cap rates automatically. According to an embodiment, the cap rate trend data can comprise a series of time/value pairs that representing actual cap rates over time. In an embodiment, the time periods can be either quarterly, meaning that values represents the actual cap rates for that quarter, or monthly, meaning that each value represents the actual cap rates for that month. Again, depending on the model, the relevant data, or both, CREST server 130 can obtain additional or substitute data from third party data server 150 or from data source 140.

According to an embodiment, the bank can select which type of trend information to use (e.g., monthly quarterly) and which source to use for obtaining the information. The bank's preferences can be stored in the CRE data store 135.

The CREST server 130 retrieves the cap rate trend information from the selected source (step 330). The retrieved data can be stored in the CRE data store 135 so that the CREST server 130 does not need to retrieve the information for subsequent calculations using the same cap rate trend data.

A determination is made as to whether the historical appraisal data and the cap rate trend information were available and were retrieved (step 240). If the data was unavailable, the CRE data store 135 can be updated to indicate that the Estimated Current Cap Rate could not be determined for this property. According to an embodiment, the CREST server 130 can attempt to access the information again at a later time. According to another embodiment, the CREST server 130 can periodically generate a report indicating that the required data could not be found for calculating the Estimated Current Cap Rate and/or other CRE stress test parameters.

According to an alternative embodiment, the CREST server 130 can be configured to provide a user interface that allows a user to manually enter the cap rate trend information. This allows the user to either select cap rate trend information from a publicly available source or manually enter the information or to manually enter hypothetical values to project how different property value trends could impact the bank's CRE portfolio.

If data was retrieved, a determination is made as to whether the Appraised Cap Rate was retrieved for the property (step 345). If the Appraised Cap Rate was not retrieved for the property, then the Estimated Current Cap Rate can be calculated by the CREST server 130 without the Appraised Cap Rate (step 380). In an embodiment, the Estimated Current Cap Rate can be calculated using the following equation (2):

Estimated Current Cap Rate=the most recent of {Cap rate trend value corresponding to “as of” date and the most recent cap rate data before the “as of” date.}

Otherwise, if the Appraised Cap Rate was available, then the Estimated Current Cap Rate can be calculated (step 350) by the CREST server 130 using the Appraised Cap Rate. According to an embodiment, the Estimated Current Cap Rate can be calculated using following equation (3):

$$Estimated Current Cap Rate = ( \frac{y - x}{x} + 100 \% ) \times Appraised Cap Rate$$

where:
x=the cap rate trend value corresponding to the Appraisal Date, and
y=the cap rate trend value corresponding to the “as of” date when the loan information was last updated.
   The CREST server 130 then can update the CRE data store 135 to include the Estimated Current Cap Rate for the property (step 360). The Estimated Current Property Value can then be used to derive other stress test estimates related to the property.

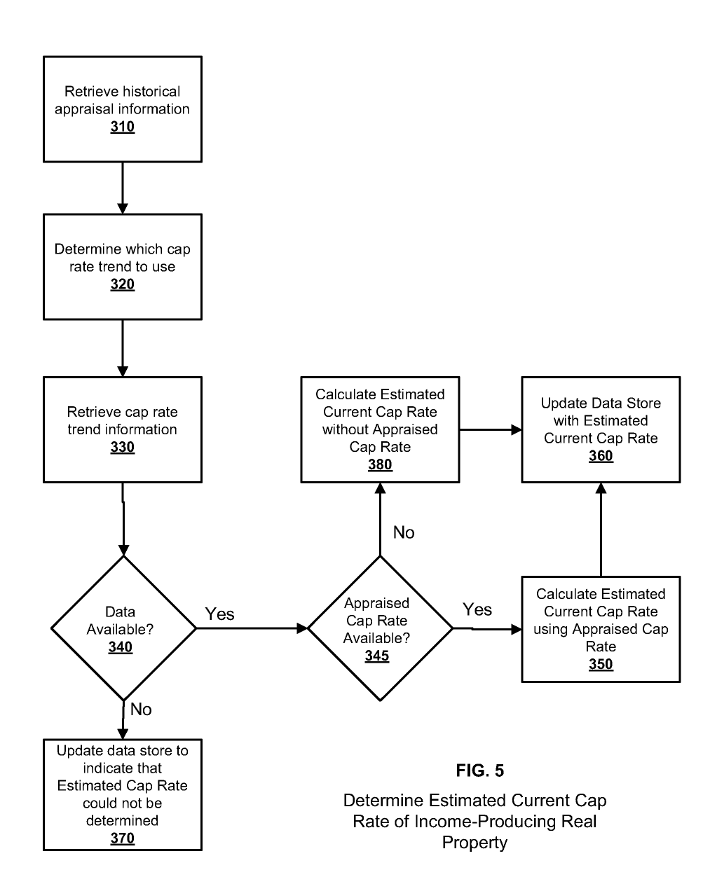

FIG. 6 is a flow diagram of a process for determining Estimated Current Net Operating Income Based on Estimated Current Property Value and Cap Rate according to an embodiment.

The Estimated Current Property Value is retrieved (step 410). In an embodiment, the Estimated Current Property Value can be stored in the CRE data store 135 and can be retrieved by the CREST server 130. In an embodiment, the Estimated Current Property Value can be determined using the process illustrated in FIG. 4.

The Estimated Current Cap Rate also can be retrieved (step 420). In an embodiment, the Estimated Current Cap Rate can be stored in the CRE data store 135 and can be retrieved by the CREST server 130. In an embodiment, the Estimated Current Cap Rate can be determined using the process illustrated in FIG. 5.

A determination is then made as to whether the Estimated Current Property Value and the Estimated Current Cap Rate values are available for the loan (step 440). One or both of these values may not be available in the CRE data store 135 if parameters used to derive these values were unavailable.

If the data was available, then the Estimated Current Net Operating Income can be calculated by CREST server 130 (step 450). In an embodiment, the Estimated Current Net Operating Income can be calculated using equation (4) below:

Estimated Current NOI=Estimated Current Property Value×Estimated Current Cap Rate

The CREST server 130 then can update the CRE data store 135 to include the Estimated Current Net Operating Income for the property (step 460). The Estimated Current Net Operating Income can then be used to derive other stress test estimates related to the property.

If the data was unavailable, the CRE data store 135 can be updated to indicate that the Current Net Operating Income could not be determined for this property (step 470). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Estimated Current Property Value and/or other CRE stress test parameters.

Thus, Crest server 130 can determine the current Net Operating Income from the outdated assessed value by processing it through value trends and cap rate trends.

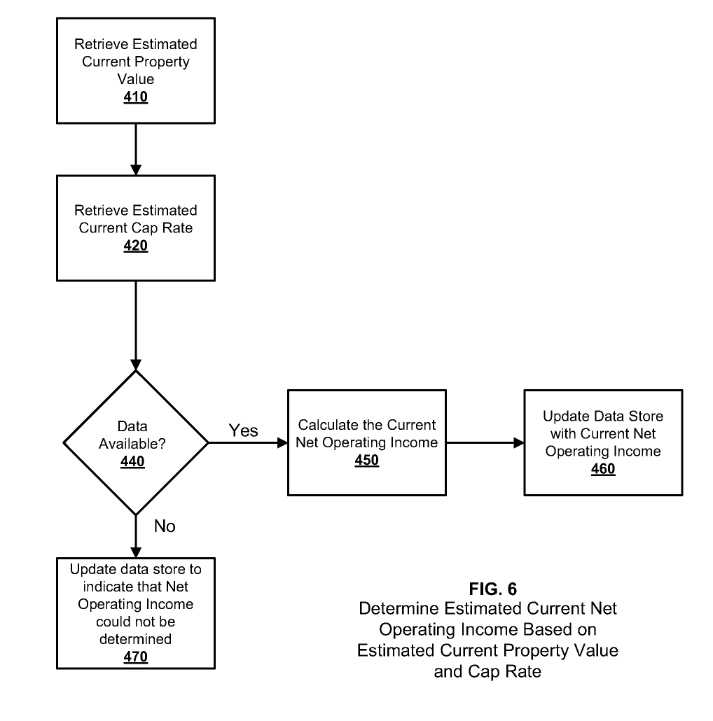

FIG. 7 is a flow diagram of a process for determining Estimated Current Loan-to-Value Ratio according to an embodiment.

The Estimated Current Property Value is retrieved (step 510). In an embodiment, the Estimated Current Property Value can be stored in the CRE data store 135 and can be retrieved by the CREST server 130. In an embodiment, the Estimated Current Property Value can be determined using the process illustrated in FIG. 4.

The Outstanding Balance on the Property is also retrieved (step 520). The Outstanding Balance on the Property represents the monetary portion of the loan associated with the real estate for which the Estimated Current Property Value was retrieved. In this process, the loan data file, e.g. ALERT file, can be retrieved from the bank server 110 and/or bank information data store 105. The loan data file includes an “as of” date that indicates when the loan data was last updated. The Outstanding Balance on the Property should be current as of the “as of” date used to determine the Estimated Current Property Value. In an embodiment, the Outstanding Balance on the Property can be included in the loan data file that was retrieved by the CREST server 130 from the bank server 110 and/or bank information data store 105 and stored in the CRE data store 135. The CREST server 130 then retrieves the Outstanding Balance on the Property from the CRE data store 135.

A determination is then made as to whether the Estimated Current Property Value and the Outstanding Balance on the Property values are available for the loan (step 540). One or both of these values may not be available in the CRE data store 135 if parameters used to derive these values were unavailable.

If the data was available, then the Estimated Current Loan-to-Value Ratio can be calculated by CREST server 130 (step 550). In an embodiment, the Estimated Current Loan-to-Value Ratio can be calculated using equation (5) below:

$$Estimated Current L T V = \frac{Outstanding Balance}{Estimated Current Property Value}$$

The CREST server 130 then can update the CRE data store 135 to include the Estimated Current Loan-to-Value Ratio for the property (step 560). The Estimated Current Loan-to-Value Ratio can then be used to derive other stress test estimates related to the property.

If the data was unavailable, the CRE data store 135 can be updated to indicate that the Estimated Current Loan-to-Value Ratio could not be determined for this property (step 570). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Estimated Current Loan-to-Value Ratio and/or other CRE stress test parameters.

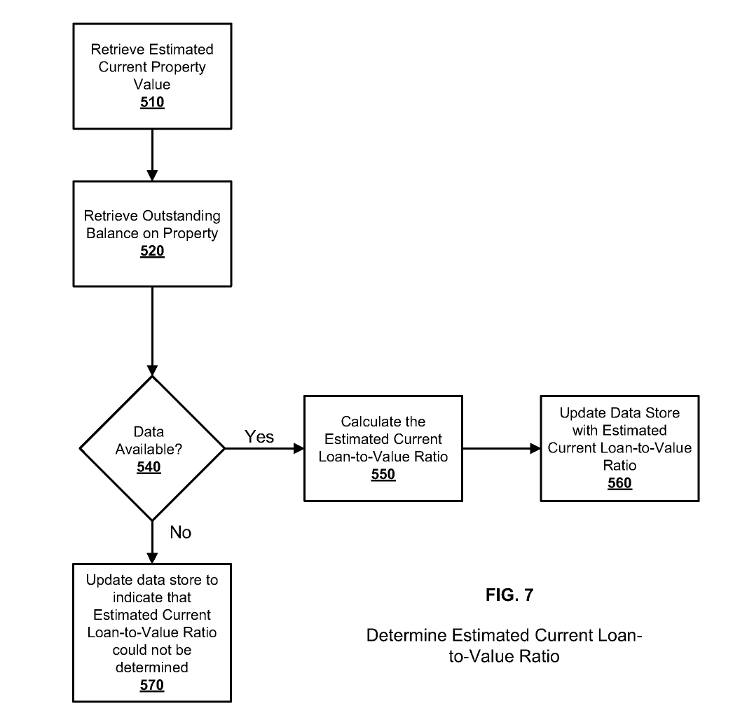

FIG. 8 is a flow diagram of a process for determining the Estimated Current Net Collateral Shortfall for a commercial real estate property according to an embodiment.

The Estimated Current Property Value is retrieved (step 610). In an embodiment, the Estimated Current Property Value can be stored in the CRE data store 135 and is retrieved by the CREST server 130. In an embodiment, the Estimated Current Property Value can be determined using the process illustrated in FIG. 4.

The Outstanding Balance on the Property is also retrieved (step 620). The Outstanding Balance on the Property represents the monetary portion of the loan associated with the real estate for which the Estimated Current Property Value was retrieved. In this process, the loan data file, e.g. ALERT file, can be retrieved from the bank server 110 and/or bank information data store 105. The loan data file includes an “as of” date that indicates when the loan data was last updated. The Outstanding Balance on the Property should be current as of the “as of” date used to determine the Estimated Current Property Value. In an embodiment, the Outstanding Balance on the Property can be included in the loan data file that was retrieved by the CREST server 130 from the bank server 110 and/or bank information data store 105 and stored in the CRE data store 135. The CREST server 130 then can retrieve the Outstanding Balance on the Property from the CRE data store 135.

A determination is then made as to whether the Estimated Current Property Value and the Outstanding Balance on the Property values are available for the loan (step 640). One or both of these values may not be available in the CRE data store 135 if parameters used to derive these values were unavailable.

If the data was available, then the Estimated Current Net Collateral Shortfall can be calculated by CREST server 130 (step 650). In an embodiment, the Estimated Current Net Collateral Shortfall (NC S) can be calculated using equation (6) below:

$$Estimated Current N C S = greater of \{ \begin{matrix}Outstanding Balance - Estimated Current Property Value \\ ∅\end{matrix}$$

The CREST server 130 then can update the CRE data store 135 to include the Estimated Current Net Collateral Shortfall for the property (step 660). The Estimated Current Net Collateral Shortfall can then be used to derive other stress test estimates related to the property.

If the data was unavailable, the CRE data store 135 can be updated to indicate that the Estimated Current Net Collateral Shortfall could not be determined for this property (step 670). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Estimated Current Net Collateral Shortfall and/or other CRE stress test parameters.

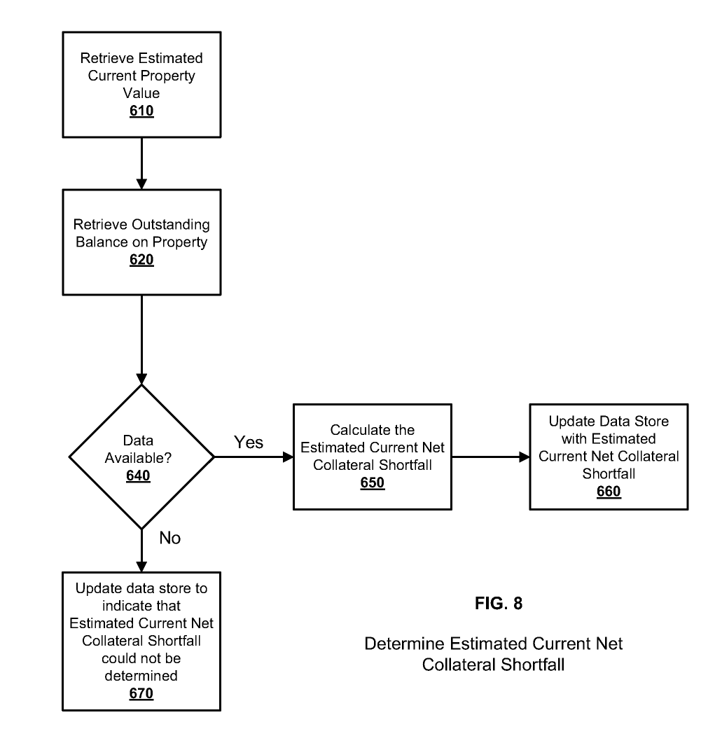

FIG. 9 is a flow diagram of a process for determining Estimated Current Debt Service Coverage Ratio (“DSCR”) of a commercial real estate property according to an embodiment. In commercial real estate, the DSCR can be used to determine if a property will be able to sustain the debt associated with the property based on cash flow. The DSCR can be determined by dividing the Estimated Net Operating Income for the property by the Loan Payment Amount for the year. The Loan Payment Amount represents the mortgage payments that the property owner is required to make for the year. If the DSCR is below 1.0, the property is not generating enough income to cover the loan payments.

The Estimated Current Net Operating Income for the property is retrieved (step 710). In an embodiment, the Estimated Current Net Operating Income can be stored in the CRE data store 135 and can be retrieved by the CREST server 130. In an embodiment, the Estimated Current Net Operating Income can be determined using the process illustrated in FIG. 6.

The Loan Payment Amount is also retrieved (step 720). As indicated above, the Loan Payment Amount represents the total loan payments that the property owner must make on the mortgage during a year period. The Loan Payment Amount is typically available in the bank information data store 105, but the Loan Payment Amount can already have been stored in the CRE data store 135 by the CREST server 130 if the CREST server 130 has already retrieved historical loan information for the property from the bank server 110 and/or bank information data store 105. The payment amount included in the historical loan information for the property can be associated with a payment frequency less than one year (e.g., monthly payment amount or quarterly payment amount). The CREST server 130 can determine the annual Loan Payment Amount by multiplying the payment data from the historical loan by an appropriate multiplier. In an embodiment, the CREST server 130 stores the calculated Loan Payment Amount in CRE data store 135.

A determination is then made as to whether the Estimated Current Net Operating Income and the Loan Payment Amount values are available for the property (step 740). One or both of these values may not be available in the CRE data store 135 if parameters used to derive these values were unavailable.

If the data was available, then the Estimated Current Debt Service Coverage Ratio can be calculated by CREST server 130 (step 750). In an embodiment, the Estimated Current Debt Service Coverage Ratio can be calculated using equation (7) below:

$$Estimated Current D S C R = \frac{Estimated Current N O I}{Loan Payment}$$

The CREST server 130 then can update the CRE data store 135 to include the Estimated Current Debt Service Coverage Ratio for the property (step 760). The Estimated Current Debt Service Coverage Ratio can then be used to derive other stress test estimates related to the property.

If the data was unavailable, the CRE data store 135 can be updated to indicate that the Estimated Current Debt Service Coverage Ratio could not be determined for this property (step 770). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Estimated Current Debt Service Coverage Ratio and/or other CRE stress test parameters.

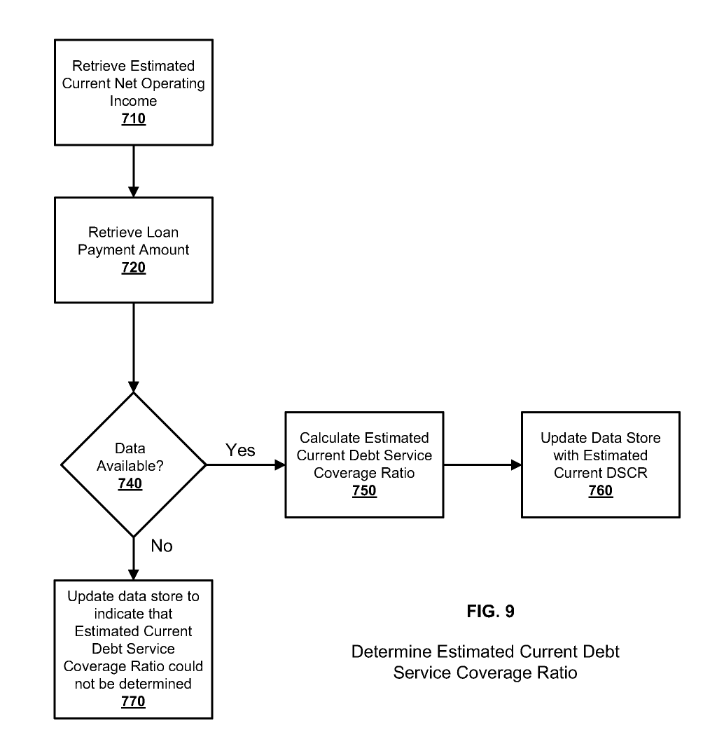

FIG. 10 is a flow diagram of a process for determining Hypothetical Loan-to-Value Ratio according to an embodiment.

The Estimated Current Property Value is retrieved (step 810). In an embodiment, the Estimated Current Property Value can be stored in the CRE data store 135 and can be retrieved by the CREST server 130.

The Outstanding Balance on the Property is also retrieved (step 820). The Outstanding Balance on the Property represents the monetary portion of the loan associated with the real estate for which the Estimated Current Property Value was retrieved. The Outstanding Balance on the Property should be current as of the “as of” date used to determine the Estimated Current Property Value. In an embodiment, the Outstanding Balance on the Property can be included in the loan data file that was retrieved by the CREST server 130 from the bank server 110 and/or bank information data store 105 and stored in the CRE data store 135. The CREST server 130 then can retrieve the Outstanding Balance on the Property from the CRE data store 135.

The Hypothetical Change in Property Value is retrieved (step 830). According to an embodiment, the Hypothetical Change in Property Value can be retrieved from the CRE data store 135. According to another embodiment, the Hypothetical Change in Property Value can be entered manually by a user via a user interface generated by the user interface module 1140. A user can enter different values for the Hypothetical Change in Property Value to determine how various stress levels on the CRE market might affect the CRE portfolio.

A determination is then made as to whether the Estimated Current Property Value, the Outstanding Balance on the Property, and the Hypothetical Change in Property Value are available for the property (step 840). One or more of these values may not be available in the CRE data store 135 if parameters used to derive these values were unavailable.

If the data was available, then the Hypothetical Loan-to-Value Ratio can be calculated by CREST server 130 (step 850). In an embodiment, the Estimated Hypothetical Loan-to-Value Ratio can be calculated using equation (8) below:

$$Est . Hypo . L T V = \frac{Outstanding Balance}{\begin{matrix}Estimated Current Property Value \times \\ ( \begin{matrix}100 \% + \\ Hypothetical Change in Property Value\end{matrix} )\end{matrix}}$$

The CREST server 130 then can update the CRE data store 135 to include the Hypothetical Loan-to-Value Ratio for the property (step 860). The Hypothetical Loan-to-Value Ratio then can be used to derive other stress test estimates related to the property.

If the data was unavailable, the CRE data store 135 can be updated to indicate that the Hypothetical Loan-to-Value Ratio could not be determined for this property (step 870). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Hypothetical Loan-to-Value Ratio and/or other CRE stress test parameters.

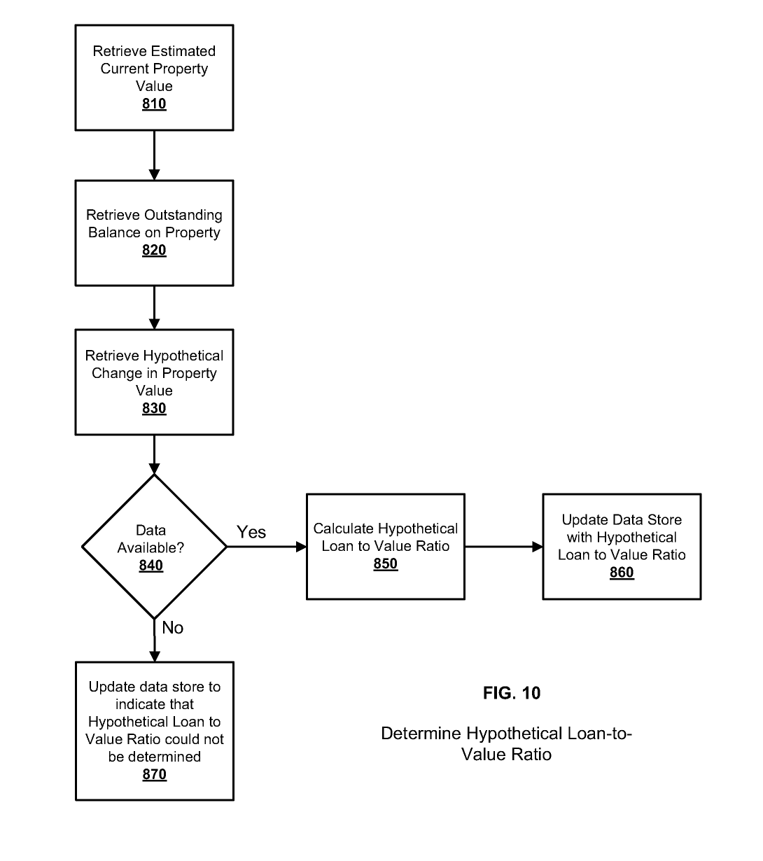

FIG. 11 is a flow diagram of a process for determining Estimated Hypothetical Net Collateral Shortfall of a commercial property according to an embodiment.

The Estimated Current Property Value is retrieved (step 910). In an embodiment, the Estimated Current Property Value can be stored in the CRE data store 135 and can be retrieved by the CREST server 130.

The Outstanding Balance on the Property is also retrieved (step 920). The Outstanding Balance on the Property represents the monetary portion of the loan associated with the real estate for which the Estimated Current Property Value was retrieved. The Outstanding Balance on the Property should be current as of the “as of” date used to determine the Estimated Current Property Value. The CREST server 130 then retrieves the Outstanding Balance on the Property from the CRE data store 135.

The Hypothetical Change in Property Value can be retrieved (step 930). The Hypothetical Change in Property Value represents a proportional change in the value of the commercial property. According to an embodiment, the Hypothetical Change in Property Value can be retrieved from the CRE data store 135. According to another embodiment, the Hypothetical Change in Property Value can be entered manually by a user via a user interface generated by the user interface module 1140. A user can enter different values for the Hypothetical Change in Property Value to determine how various stress levels on the CRE market might affect the CRE portfolio.

A determination is then made as to whether the Estimated Current Property Value, the Outstanding Balance on the Property, and the Hypothetical Change in Property Value are available for the property (step 940). One or more of these values may not be available in the CRE data store 135 if parameters used to derive these values were unavailable.

If the data was available, then the Hypothetical Net Collateral Shortfall can be calculated by CREST server 130 (step 950). In an embodiment, the Hypothetical Net Collateral Shortfall can be calculated using equation (9) below:

Estimated Hypothetical Net Collateral Shortfall=greater of {Outstanding Balance−(Estimated Current Property Value x(100%+Hypothetical Change in Property Value)),0}

The CREST server 130 then can update the CRE data store 135 to include the Hypothetical Net Collateral Shortfall for the property (step 960). The Hypothetical Net Collateral Shortfall can then be used to derive other stress test estimates related to the property.

If the data was unavailable, the CRE data store 135 can be updated to indicate that the Hypothetical Net Collateral Shortfall could not be determined for this property (step 970). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Hypothetical Net Collateral Shortfall and/or other CRE stress test parameters.

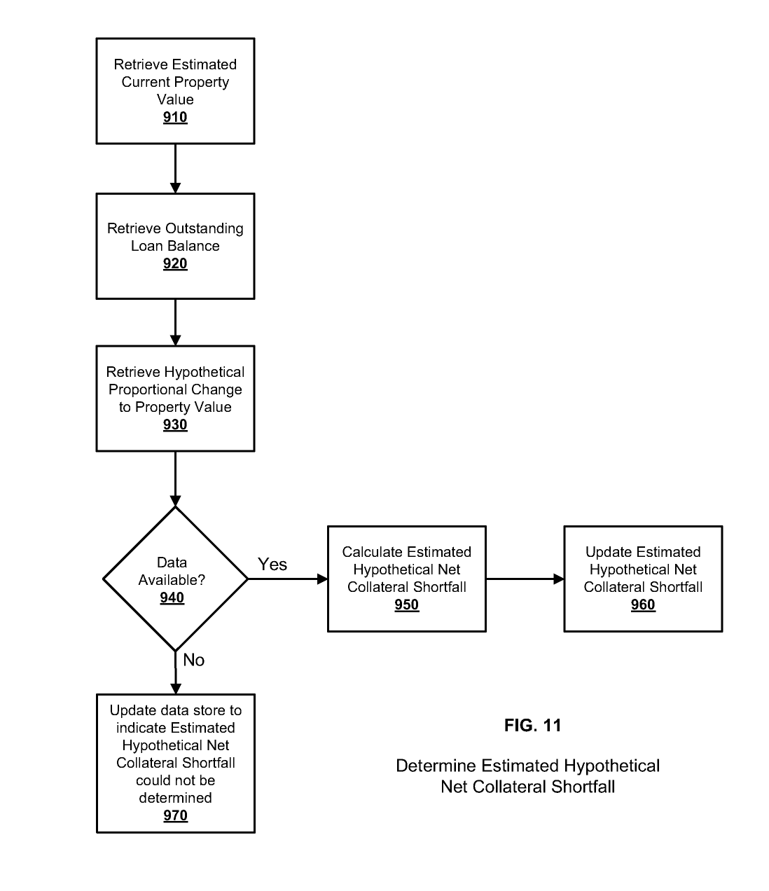

FIG. 12 is a flow diagram of a process for determining Estimated Hypothetical Debt Service Coverage Ratio for a commercial property according to an embodiment. In commercial real estate, the Estimated Hypothetical DSCR can be used to determine if a property will be able to sustain the debt associated with the property based on cash flow based on the Estimated Current Net Operating Income for the property, hypothetical changes in the Net Operating Income, and hypothetical changes to the Interest Rate on the loan. If the Estimated Hypothetical DSCR is below 1.0, the property may not generate enough income to cover the loan payments based on hypothetical changes estimated changes to the operating income and the interest rate.

The Estimated Current Net Operating Income for the property is retrieved (step 1005). In an embodiment, the Estimated Current Net Operating Income can be stored in the CRE data store 135 and can be retrieved by the CREST server 130. In an embodiment, the Estimated Current Net Operating Income can be determined using the process illustrated in FIG. 6.

The Hypothetical Change in Net Operating Income is retrieved (step 1010). In an embodiment, the Hypothetical Change in Net Operating Income can be stored in the CRE data store 135 and can be retrieved by the CREST server 130. According to an embodiment, the Hypothetical Change in Property Value can be retrieved from the CRE data store 135. According to another embodiment, the Hypothetical Change in Net Operating Income can be entered manually by a user via a user interface generated by the user interface module 1140. A user can enter different values for the Hypothetical Change in Net Operating Income to determine how various stress levels on the CRE market might affect the CRE portfolio.

The Interest Rate for the loan on the commercial property is retrieved (step 1015). The Interest Rate should available from the bank server 110 and/or bank information data store 105 any can already have been stored in the CRE data store 135 by the CREST server 130 if the CREST server 130 has already retrieved historical loan information for the property from the bank server 110 and/or bank information data store 105.

The Hypothetical Change in Interest Rate is retrieved (step 1020). In an embodiment, the Hypothetical Change in Interest Rate can be stored in the CRE data store 135 and can be retrieved by the CREST server 130. The Hypothetical Change in Interest Rate is a hypothetical basis point change for the interest rate for the loan on the commercial property. For example, a change of +1 basis point is equal to an increase in the interest rate one 1% (e.g., from 5% to 6%). According to an embodiment, the Hypothetical Change in Interest Rate can be retrieved from the CRE data store 135. According to another embodiment, the Hypothetical Change in Interest Rate can be entered manually by a user via a user interface generated by the user interface module 1140. A user can enter different values for the Hypothetical Change in Interest Rate to determine how various stress levels on the CRE market might affect the CRE portfolio.

The Outstanding Balance on the Property is also retrieved (step 1025). The Outstanding Balance on the Property represents the monetary portion of the loan associated with the real estate for which the Estimated Current Property Value was retrieved. According to an embodiment, the Estimated Current Property Value can be determined using the process illustrated in FIG. 4. In this process, the loan data file, e.g. ALERT file, can be retrieved from the bank server 110 and/or bank information data store 105. The loan data file includes an “as of” date that indicates when the loan data was last updated. The Outstanding Balance on the Property should be current as of the “as of” date used to determine the Estimated Current Property Value. In an embodiment, the Outstanding Balance on the Property can be included in the loan data file that was retrieved by the CREST server 130 from the bank server 110 and/or bank information data store 105 and can be stored in the CRE data store 135. The CREST server 130 then retrieves the Outstanding Balance on the Property from the CRE data store 135.

The Amortization Term for the loan on the commercial property is retrieved (step 1030). The Amortization Term represents the length of time between the “as of” date where the loan information ahs been last updated and the date at which the loan will be completely paid off. In an embodiment, the CREST server 130 can retrieve the Amortization Term from the CRE data store 135.

A determination is then made as to whether the each of the data elements used to calculate the Estimated Hypothetical Debt Service Coverage Ratio are available for the property (step 1040). One or more of these values may not be available in the CRE data store 135 if parameters used to derive these values were unavailable.

If the data was available, then the Estimated Hypothetical Debt Service Coverage Ratio can be calculated by CREST server 130 (step 1050). In an embodiment, the Estimated Hypothetical Debt Service Coverage Ratio can be calculated using equation (10) below:

$$Est . Hypo . D S C R = \frac{\begin{matrix}Est . Cur . N O I \times \\ ( \begin{matrix}100 \% + \\ Hyp . Change in N O I\end{matrix} )\end{matrix}}{\begin{matrix}P M T \\ ( \begin{matrix}Am . Term , Outstanding Balance , \\ Int . Rate + Hyp . Change in Int . Rate\end{matrix} )\end{matrix}}$$

where PMT represents a function that calculates the monetary amount required to be paid on a recurring basis in order to completely pay down the Outstanding Balance and accrued interest within the specified Amortization Term.

The CREST server 130 then can update the CRE data store 135 to include the Estimated Hypothetical Debt Service Coverage Ratio for the property (step 1060). The Estimated Hypothetical Debt Service Coverage Ratio can then be used to derive other stress test estimates related to the property.

If the data was unavailable, the CRE data store 135 can be updated to indicate that the Estimated Hypothetical Debt Service Coverage Ratio could not be determined for this property (step 1070). According to an embodiment, the CREST server 130 can attempt to access the information again at a later time and/or initialize the processes or processes that generate the missing data. According to another embodiment, the CREST server 130 can periodically generate a report indicating that the required data could not be found for calculating the Estimated Hypothetical Debt Service Coverage Ratio and/or other CRE stress test parameters.

Often the contractual term on a loan is shorter than amortization term with a “balloon payment” at the end of the term, and the bank server 110 keeps track of the contractual term not the amortization term. Accordingly, the CREST server 130 can be configured to calculate an “implied amortization term”, for use in equation 10, based upon the current outstanding balance, interest rate, and payment amount. For example, the calculation can be one of the following: 1. Normal amortization—the outstanding balance reduces as payment is made. The loan will be paid off in certain years; 2. Interest only—the outstanding balance will not change forever; and 3. Negative amortization—the loan's outstanding balance grows as payment is made. Thus, in general, the amortization term is calculated from outstanding balance, interest rate, and payment amount.

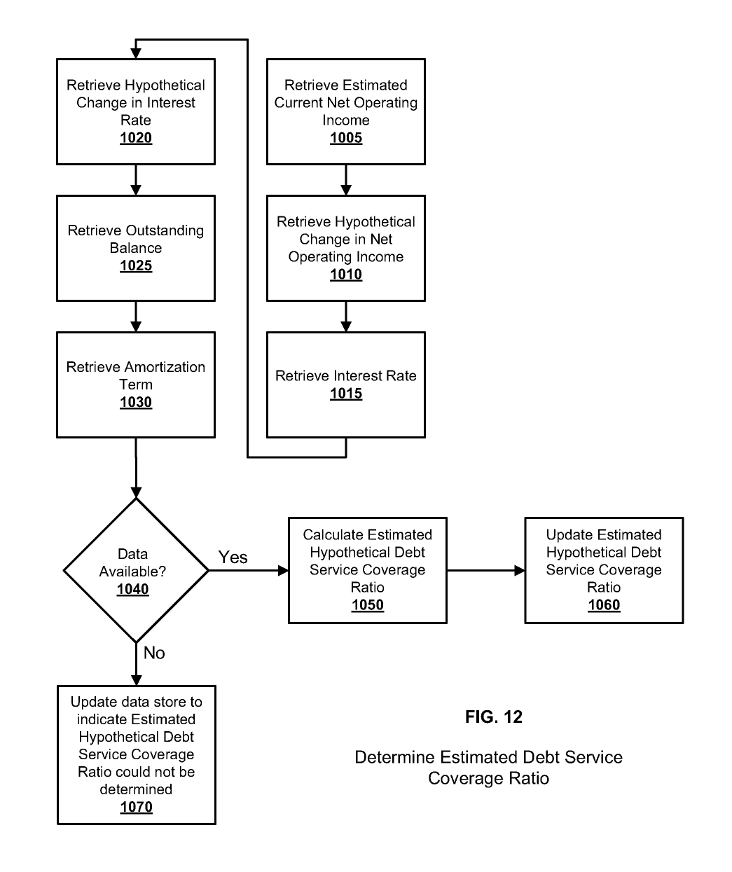

FIG. 13 is a block diagram illustrating an example CREST server 130 according to an embodiment. In the illustrated embodiment, the CREST server comprises a data management module 1120, rules module 1130, a user interface module 1140, a data interface module 1150, and a report module 1170.

Data management module 1120 provides an interface between the CREST server 130 and the CRE data store 135. The data management module 1120 can be configured to access data from the CRE data store 135, update or remove existing data in the data store, and to add additional data to the data store. According to an embodiment, the CRE data store 135 can be a relational database and the data management module 1120 provides an interface for submitting queries to the database.

Data management module 1120 also includes several modules for processing information received from the bank server 110 and bank information data store 105. In an embodiment, the CREST server 130 receives loan data file, such as an Automated Loan Examination Review Tool (“ALERT”) file, from the bank that contains loan information. An ALERT file contains loan information for one or more loans and is available from most bank systems. Although as noted above, other types of formats for the loan data can be used and are supported. The information contained in the ALERT file can be used assess the performance of the bank's portfolio of loans. According to an embodiment, the data management module 1120 extracts the collateral value of the property (as of the last assessment date) and the valuation date (the date at which the assessment of the value of the property was made). The CREST server 130 can use this data as a starting point for the stress test calculations.

It is important to note that the information included in the loan data file is only as current as the bank information from which the loan data file was generated. Information included in the loan data file, such as the current value of the property and the cap rate of the property, can be and is likely to be out of date. This information is typically determined by a professional property assessor and it may have been some time since an assessment has been made on the property. Property values may have risen or fallen significantly since the assessment was made. According to an embodiment, the data management module is configured to extract loan information from the loan data files and to adjust the potentially out of date information received from the bank using publicly available trend information to create adjusted values for the loan that can provide a more accurate representation of the loan performance based on current market conditions rather than market conditions at the time that the loan information was captured by the bank. The adjusted data can be used to generate various reports that provide estimates of the potential performance of the bank's CRE portfolio based on the current market conditions.

Analytics module 1130 allows an administrator to configure, define, and/or modify the analytics programs 132 used to evaluate the bank loan information and to automatically determine information deficiencies, missing information, stale information, or information that should be substituted with more accurate information or more easily quantifiable information for purposes of testing. The analytics programs 132 enable the CREST server 130 to be able to identify what information needs to be added, deleted, updated, or substituted. The analytics programs can be configured based on the type of model being applied, the type of risk being assessed, the types of properties being analyzed, etc. According to an embodiment, the analytics programs 132 can include a default set of analytics that can be modified to customize the system for a particular bank.

User interface module 1140 generates user interfaces that allow users and administrators to interact with the CRE stress testing system to initiate or schedule stress testing, to generate reports, configure the analytic programs that determine the behavior of the system, and execute other functions of the CRE stress testing system.

Data interface module 1150 provides interfaces for connecting to external data sources, such as external data source 140 and third party information server 150, in order to obtain CRE trend information used in the data models for CRE stress testing. In an embodiment, data interface module 1150 also provides interface for accessing bank server 110 and bank information data store 105. In an embodiment, the data interface module 1150 can access the data in bank information data store 105 indirectly through bank server 110 and/or bank information data store 105. In an embodiment, the data interface module 1150 can implement one or more proprietary interfaces for accessing the data from external data sources.

Stressed condition calculation module 1160 performs calculations to forecast CRE loan performance. The stress condition calculation module 1160 can use the adjusted/estimated values generated by the data management module 1120 as well as stress factor information to calculate various stressed value estimated for the CRE loans in the bank's CRE portfolio.

Report module 1170 generates CRE stress test reports from data in the CRE data store 135. Various reports can be generated, such as the CRE testing for one or more specific loans in the bank's portfolio, or reports covering the bank's entire CRE portfolio. According to an embodiment, the report module 1170 can include a segmentation module (not shown). The segmentation module can be configured to group loans into various categories (referred to herein as “segments”) for reporting purposes. Segments can be manually defined by users. For example, the segmentation module can be configured to work in conjunction with the user interface module 1140 to provide a user interface that allows users to define segments into which loans will be grouped on the CRE stress testing reports. The CREST server 130 can also be configured to automatically segment loans for reports. According to an embodiment, the CRE data store 135 can include a set of predefined report templates that each include a set of predefined segments to use for generating the reports. According to an embodiment, the reporting module 1170 and the segmentation module can be configured to allow a user to customize the existing reports and/or to generate new reports including selecting the segments to be used for grouping loans in the report.

The segments can be based on various loan characteristics. Some examples of segments into which loans might be grouped include “CRE construction,” “CRE with rental income,” and “Multi-Family Residential Loan.” These are merely a few examples of the types of segments that can be defined based on the types of property. Other segments can be defined based on the loan information available to the report module 1170. For example, the each segment could be broken down into subcategories such as “borrower's city,” “business type,” “by DSCR,” and “by loan to value ratio.” These are merely examples of a few of the types of sub-segments that can be defined.” Other sub-segments can be defined based on the loan information available to the report module 1170. According to an embodiment, each segment can be further broken down into multiple sub-segments. Each sub-segment can then be further broken down in additional sub-segments.

In an embodiment, any new loans that are added to the system are automatically categorized and included in the stress testing reports the next time that the reports are regenerated.

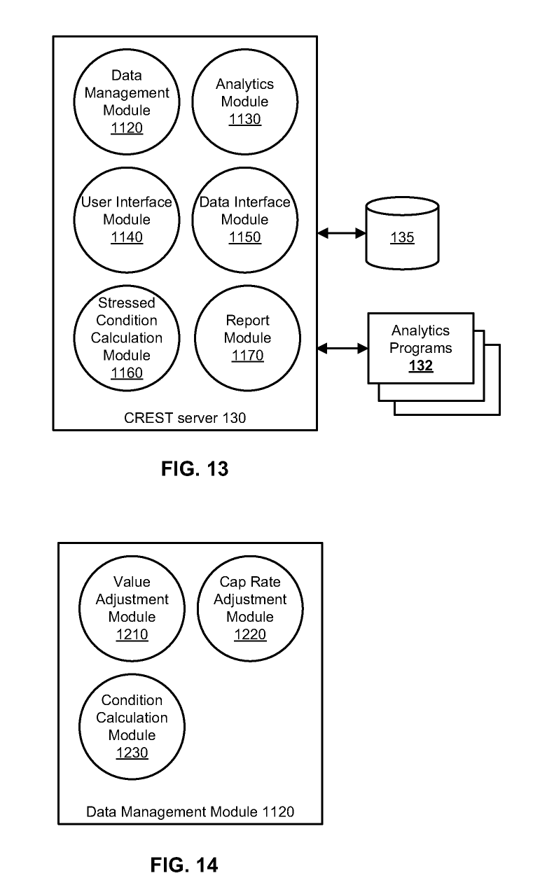

FIG. 14 is a block diagram illustrating an example data management module according to an embodiment. As illustrated above in FIG. 13, the CREST server 130 can include a data management module 1120. According to an embodiment, the data management module 1120 can include a value adjustment module 1210, a cap rate adjustment module 1220, and a condition calculation module 1230. The value adjustment module 1210 can be configured to determine an estimated current value of a commercial property. According to an embodiment, the value adjustment module 1210 can be configured to perform the process illustrated in FIG. 4 for determining an Estimated Present Value of Property. According to an embodiment, the cap rate adjustment module 1220 can be configured to determine a current cap rate for a commercial property. According to an embodiment, the cap rate adjustment module 1220 can be configured to perform the process illustrated in FIG. 5 for determining Estimated Current Cap Rate of Income-Producing Real Estate.

According to an embodiment, the value adjustment module 1210 can be configured to allow a user manually input different property value and/or cap rate trend information to determine how the value of the property and/or the cap rate would be affected by different trends. For example, a user can enter different trends based on the geographic location of the commercial property and/or other property type characteristics in order to determine how various trends might affect the value of the property. In an embodiment, the user interface module 1210 can generate user interface that allows a user to enter trend information manually. According to an embodiment, the CREST server 130 can also be configured to retrieve publicly available trend information from a publicly available data source, such as third party server 150 or CRE data source 140, that the value adjustment module 1210 and/or the cap rate adjustment module 220 can use to determine the estimated property value and the estimated cap rate. This allows the CREST server 130 to automatically calculate estimated property values for a property without requiring that the user manually enter trend data. According to some embodiments, the CREST server 130 can automatically access trend data from publicly available sources and the value adjustment module 1210 can calculate the estimated property value for the property, but a user can override the trend data used by the by the value adjustment module 1210 and enter a different value for the value adjustment module 1210 to use in the calculations.

In an embodiment, the condition calculation module 1230 can be configured to determine various estimated values for a commercial property, such as the estimated current net operating income, the estimate current loan-to-value ratio, the estimated current net collateral shortfall, and the estimated current debt service coverage ratio of the property. In an embodiment, the condition calculation module 1230 can be configured to perform the process as illustrated in FIGS. 7-12, e.g., for determining Estimated Current Net Operating Income of a commercial property based on Estimated Current Property Value and Cap Rate, Estimated Current Loan-to-Value Ratio of a commercial property, Estimated Current Net Collateral Shortfall of a commercial property, Estimated Current Debt Service Coverage Ratio of a commercial property, etc.

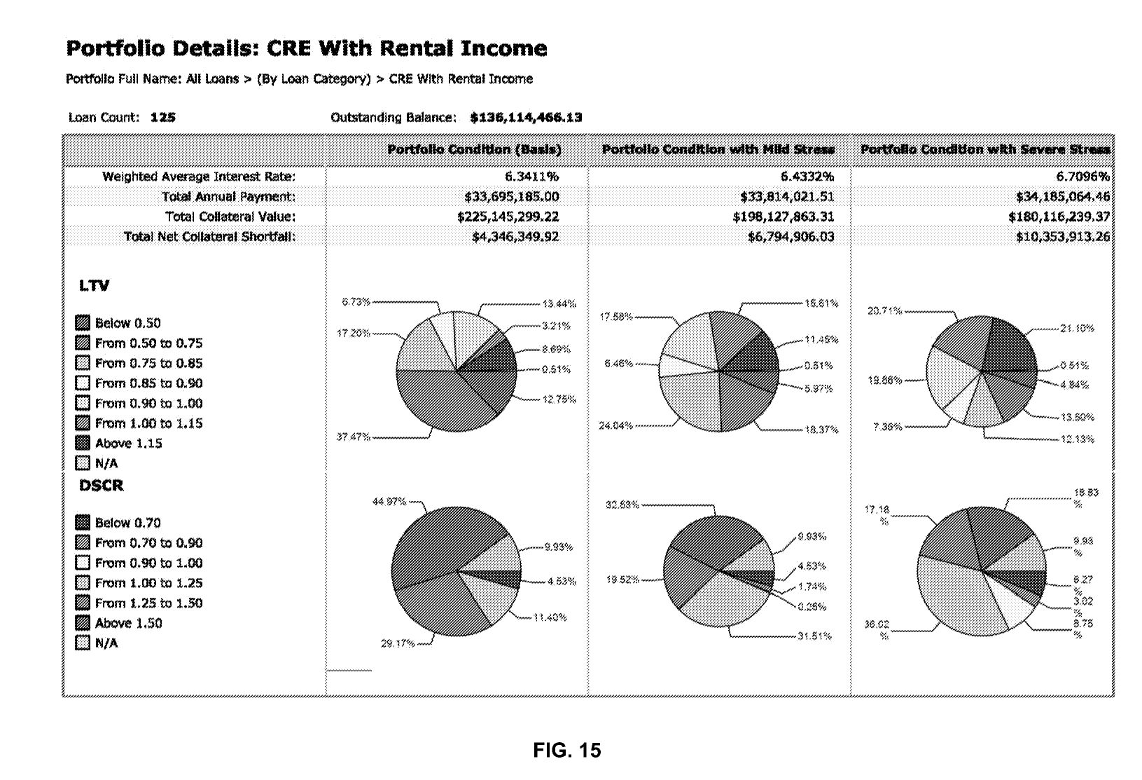

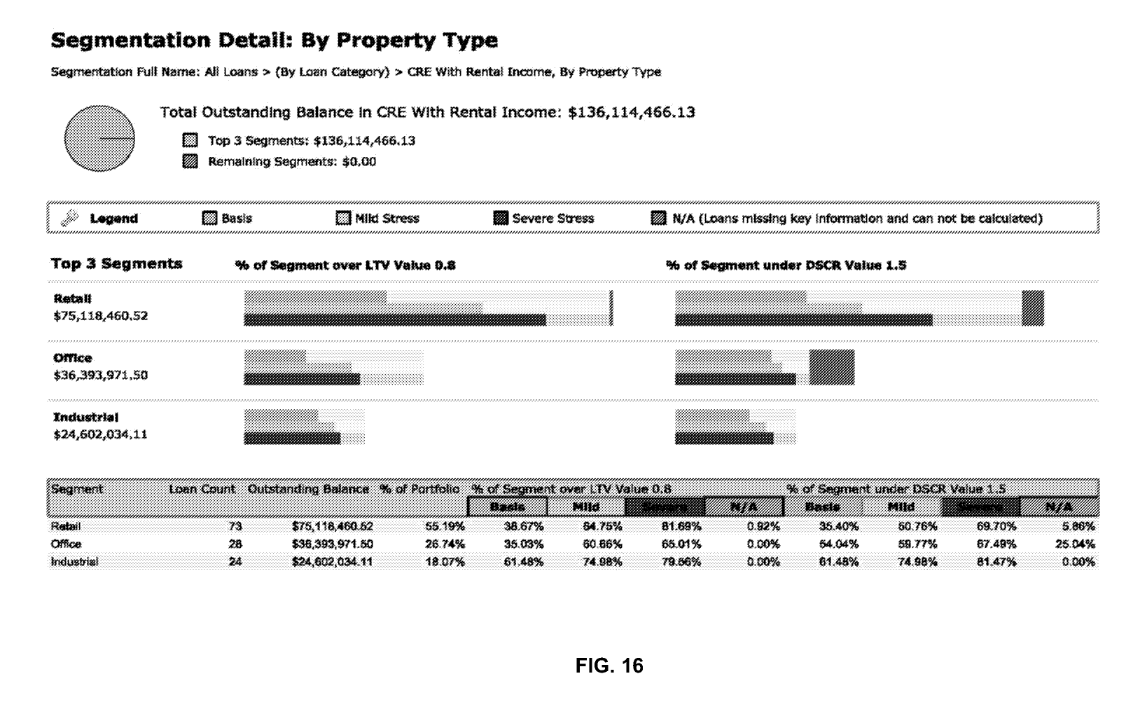

FIG. 15 is an example page from a CRE Stress Test Report that can be generated by report module 1170 of the CREST server 130 according to an embodiment, and FIG. 16 is another example page from a CRE Stress Test Report that can be generated by report module 1170 of the CREST server 130 according to an embodiment. The CRE Stress Test report illustrated in FIGS. 15 and 16 provide information that can used to quickly identify high-risk areas in a bank's CRE portfolio. According to an embodiment, the segmentation module of report module 1170 can assign different stress factors based on loan characteristics, and the stressed condition calculation module 1160 can calculate each loan's stressed condition based on these stress factors assigned by the segmentation module. According to an embodiment, the report module 1170 can be configured to the group the stressed results in various ways to more readily reveal which segments of the CRE portfolio are the high-risk parts of the portfolio (i.e., those segments that could potentially receive the most damage from stress). In the embodiment illustrated in FIGS. 15 and 16 includes a comparison of baseline data (no stress), mild stress, and severe stress scenarios. The stress levels for each level can be determined by selecting different stress factors for each of the stress levels included in the report. In an embodiment, different stress factors values can be provided to stressed condition calculation module 1160 which then can calculate the Hypothetical Loan-to-Value Ratio, the Estimated Hypothetical Net Collateral Shortfall, the Estimated Hypothetical Net Collateral Shortfall, and/or other values for a loan based on the stress factor values. According to an embodiment, the CREST server 130 provides a user interface via user interface module 1140 that allows a user to define the stress test factors to be used to generate a CRE stress test report.

Those of skill in the art will appreciate that the various illustrative modules, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, engines, and method steps described in connection with the embodiments disclosed herein can be implemented or performed with computer hardware including a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The system disclosed herein can be serviced in various ways such as stand-alone application, client-server application, web application, hand-held device application or in a combination of those.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A system for performing stress testing on commercial real estate loans, the system comprising:
a commercial real estate stress test (CREST) server configured to automatically perform real estate stress testing for commercial real estate, wherein the CREST server is configured to perform the following steps:
receiving loan information for a commercial property from a bank;
retrieving real estate trend data from an external data source;
estimate various values for use in automated commercial real estate stress testing based on the loan information from the bank and the real estate trend data from the external data source; and
a commercial real estate (CRE) data store connected to the CREST server and configured to store data for the CREST server.

2. The system of claim 1, further comprising analytics programs executable by the CREST server, wherein the analytics programs configured to evaluate the loan data received from the bank and to identify which information needs to be updated or replaced using the commercial real estate data from the external data source.

3. The system of claim 1, wherein estimating values further comprises determining an estimated present value of the commercial property based on an appraised collateral value for the property included in the loan information received from the bank and property value trend information included in the real estate trend data retrieved from an external source.

4. The system of claim 3, wherein the loan information also includes as of date information for the appraised collateral value.

5. The system of claim 3, wherein the property value trend information is presented as a series of time/value pairs representing the proportional change of collateral values over a time period.

6. The system of claim 5, wherein the time period is monthly or quarterly.

7. the system of claim 5, wherein the time/value pairs are expressed as index values.

8. The system of claim 5, wherein the time/value pairs are expressed as prices per square foot.

9. The system of claim 3, wherein determining an estimated present value of the commercial property further comprises:
selecting a first property trend value (y) representing proportional changes in property values over time from the property value trend information, the first property trend value corresponding to a date when the loan information was last updated;
selecting a second property trend value (x) representing proportional changes in property values over time from the property value trend information, the second property trend value corresponding to a date when the property was appraised;
calculating the estimated current property value of the property using the following equation:
(((y−x)/x)+100%)*Appraised Collateral Value; and
storing the estimated current property value in the CRE data store.

10. The system of claim 3, wherein estimating various values further comprises determining an estimated current cap rate of the commercial property based on cap rate information included in the loan information and cap rate trend information included in the real estate trend data retrieved from an external source.

11. The system of claim 10, wherein the loan information also includes as of date information related to the cap rate information.

12. The system of claim 10, wherein the cap rate trend information is presented as a series of time/value pairs representing actual cap rates over a time period.

13. The system of claim 12, wherein the time period is monthly or quarterly.

14. The system of claim 10, wherein determining the estimated current cap rate of the commercial property further comprises:
selecting a first cap rate trend value (y) representing proportional changes in cap rates over time from the property value trend information, the first cap rate trend value corresponding to a date when the loan information was last updated;
selecting a second cap rate trend value (x) representing proportional changes in cap rates over time over time from the property value trend information, the second cap rate trend value corresponding to a date when the property was appraised;
calculating the estimated current cap rate of the property using the following equation:
(((y−x)/x)+100%)*Appraised Cap Rate; and
storing the estimated current cap rate in the CRE data store.

15. The system of claim 10, wherein estimating various values further comprises determining an estimated net operating income of the commercial property based on the estimated present value of the commercial property and the estimated current cap rate of the commercial property.

16. The system of claim 15, wherein determining the estimated net operating income of the commercial property further comprises:
calculating the estimated current cap rate of the property using the following equation:
(estimated present value)×(estimated current cap rate); and
storing the estimated net operating income in the CRE data store.

17. A system for estimating a net operating income for a property, the system comprising:
a commercial real estate stress test (CREST) server configured to automatically perform real estate stress testing for commercial real estate, wherein the CREST server is configured to perform the following steps:
receiving loan information for a commercial property from a bank;
retrieving real estate trend data from an external data source;
determining an estimated present value of the commercial property based on an appraised collateral value for the property included in the loan information received from the bank and property value trend information included in the real estate trend data retrieved from an external source;
determining an estimated current cap rate of the commercial property based on cap rate information included in the loan information and cap rate trend information included in the real estate trend data retrieved from an external source;
determining an estimated net operating income of the commercial property based on the estimated present value of the commercial property and the estimated current cap rate of the commercial property; and
a commercial real estate (CRE) data store connected to the CREST server and configured to store data for the CREST server.

18. The system of claim 17, further comprising analytics programs executable by the CREST server, wherein the analytics programs configured to evaluate the loan data received from the bank and to identify which information needs to be updated or replaced using the commercial real estate data from the external data source.

19. The system of claim 17, wherein determining an estimated present value of the commercial property further comprises:
selecting a first property trend value (y) representing proportional changes in property values over time from the property value trend information, the first property trend value corresponding to a date when the loan information was last updated;
selecting a second property trend value (x) representing proportional changes in property values over time from the property value trend information, the second property trend value corresponding to a date when the property was appraised;
calculating the estimated current property value of the property using the following equation:
(((y−x)/x)+100%)*Appraised Collateral Value; and
storing the estimated current property value in the CRE data store.

20. The system of claim 17, wherein determining the estimated current cap rate of the commercial property further comprises:
selecting a first cap rate trend value (y) representing proportional changes in cap rates over time from the property value trend information, the first cap rate trend value corresponding to a date when the loan information was last updated;
selecting a second cap rate trend value (x) representing proportional changes in cap rates over time over time from the property value trend information, the second cap rate trend value corresponding to a date when the property was appraised;
calculating the estimated current cap rate of the property using the following equation:
(((y−x)/x)+100%)*Appraised Cap Rate; and
storing the estimated current cap rate in the CRE data store.

21. The system of claim 17, wherein determining the estimated net operating income of the commercial property further comprises:
calculating the estimated current cap rate of the property using the following equation:
(estimated present value)×(estimated current cap rate); and
storing the estimated net operating income in the CRE data store.

22. The system of claim 17, wherein the loan information also includes as of date information for the appraised collateral value.

23. The system of claim 17, wherein the property value trend information is presented as a series of time/value pairs representing the proportional change of collateral values over a time period.

24. The system of claim 23, wherein the time period is monthly or quarterly.

25. The system of claim 23, wherein the time/value pairs are expressed as index values.

26. The system of claim 23, wherein the time/value pairs are expressed as prices per square foot.

27. The system of claim 17, wherein the loan information also includes as of date information related to the cap rate information.

28. The system of claim 17, wherein the cap rate trend information is presented as a series of time/value pairs representing actual cap rates over a time period.

29. The system of claim 28, wherein the time period is monthly or quarterly.
